(19) United States
(12) Patent Application Publication
(10) Pub. No.: US 2012/0097817 A1
(43) Pub. Date: Apr. 26, 2012

(54) Fastening Structure for Lamp Holder

(76) Inventor: CHIEN-TING LIN, Santa Fe Springs, CA (US)

(21) Appl. No.: 13/280,513

(22) Filed: Oct. 25, 2011

(30) Foreign Application Priority Data
Oct. 25, 2010 (CN) 201020574295.0

(51) Int. Cl. F21V 21/00

(52) U.S. Cl. 248/314

(57) ABSTRACT

A fastening structure for a lamp holder is disclosed, which includes a main body, a mounting unit and a first securing unit. One end of the main body has an assembly hole and a second securing unit, and the other end of the main body is extended with an engagement portion having a transversely central hole. The mounting unit is mounted at a side of the engagement portion of the main body. The first securing unit passes through the transversely central hole of the engagement portion of the main body and secures the mounting unit to the engagement portion of the main body along an inclined angle. With the engagement of the mounting unit and the main body by the first securing unit along an inclined angle, it is very fast and convenient to assemble the lamp holder to the fastening structure without causing any interference between components.

### BACKGROUND OF THE INVENTION

1. Field of the Invention

The present invention relates to a connection structure, and more particular to a fastening structure for a lamp holder.

2. The Prior Arts

In photographing, radio and television, movie making, and live broadcast industries, many photographing, image capturing, and illuminating apparatuses are required. During photographing, a lamp holder has to be assembled with a supporter or a post, and a canopy. A connection structure (a fastening structure for a lamp holder) is required to connect the supporter and the lamp holder. However, conventional fastening structures for a lamp holder often has the drawbacks of being time consuming and labor intensive during assembling.

Please refer to FIG. 1, which is a perspective view showing a conventional fastening structure for a lamp holder. The conventional fastening structure 100 includes a main body 11, a mounting unit 12, a securing member 13, a first securing unit 14, and a second securing unit 15. One end of the main body 11 is adapted for being assembled to a supporter by the second securing unit 15. The other end of the main body 11 is mounted with the mounting unit 12, which is adapted to be engaged to a lamp holder by an engagement hole 121 of the mounting unit 12. However, the main body 11, the mounting unit 12, and the securing member 13 are secured together by the first securing unit 14 in transverse to a longitudinal direction of the main body 11. Such design requires the mounting unit 12 to be extended outwards to a predetermined length so as to keep an operational space for the assembling and disassembling of the lamp holder.

Therefore, it is desired to provide an improved fastening structure for a lamp holder.

### SUMMARY OF THE INVENTION

A primary objective of the present invention is to provide a fastening structure for a lamp holder, which can solve the above-mentioned problems.

In order to achieve the above-mentioned objective, a fastening structure for a lamp holder according to the present invention includes a main body, a mounting unit and a first securing unit. One end of the main body has an assembly hole and a second securing unit, and the other end of the main body is extended with an engagement portion having a transversely central hole. The mounting unit is mounted at a side of the engagement portion of the main body. The first securing unit passes through the transversely central hole of the engagement portion of the main body and secures the mounting unit to the engagement portion of the main body along an inclined angle.

According to the present invention, the mounting unit and the main body are secured together by the first securing unit along an inclined angle. Thus, it is very convenient to assemble the lamp holder to the fastening structure without causing any interference of the first securing unit with the lamp holder and other components, for example a canopy, during assembling. Furthermore, it is also to provide a more sufficient space for securing the lamp holder to the mounting unit by the first securing unit, and it is also more convenient in operating the first securing unit. In addition, the second mounting portion of the mounting members can be designed to be shorter in length than the conventional structures. With such a special design, the fastening structure of the present invention has the advantages of being capable of being rapidly and conveniently assembled to or disassembled from the lamp holder, which improve the shortcomings of the conventional fastening structures.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of a conventional fastening structure for a lamp holder;

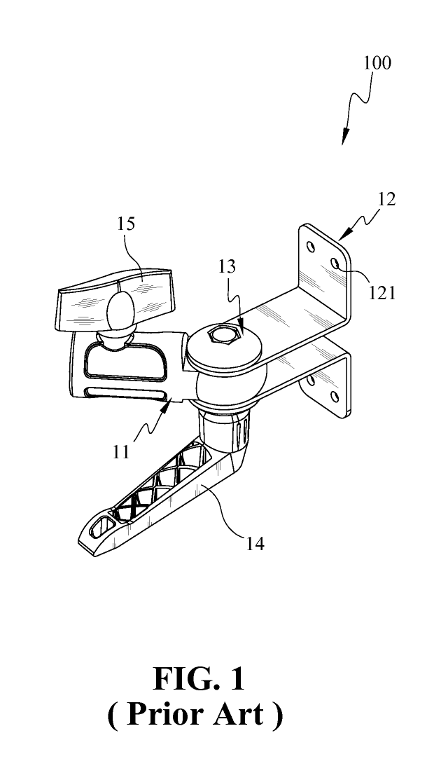

FIG. 2 is a perspective disassembled view showing a fastening structure for a lamp holder according to the present invention, which is to be assembled with a supporter and the lamp holder;

FIG. 3 is a perspective view showing the fastening structure of the present invention, the supporter, and the lamp holder are assembled together;

FIG. 4 is a cross sectional view taken along an inclined angle to show the fastening structure of the present invention; and

FIG. 5 is a cross sectional view taken along another angle to show the fastening structure of the present invention.

### DETAILED DESCRIPTION OF THE PREFERRED EMBODIMENT

The accompanying drawings are included to provide a further understanding of the present invention, and are incorporated in and constitute a part of this specification. The drawings together with the description illustrate embodiments of the present invention and serve to explain the principles of the present invention.

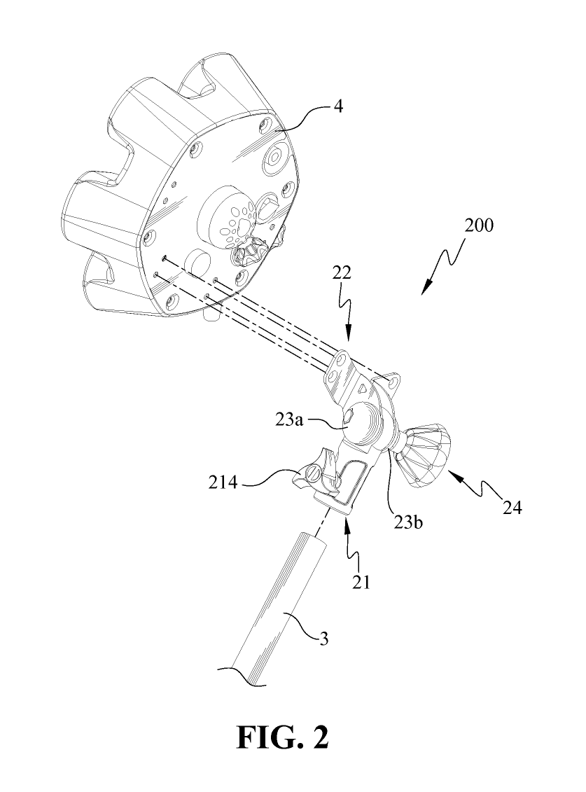

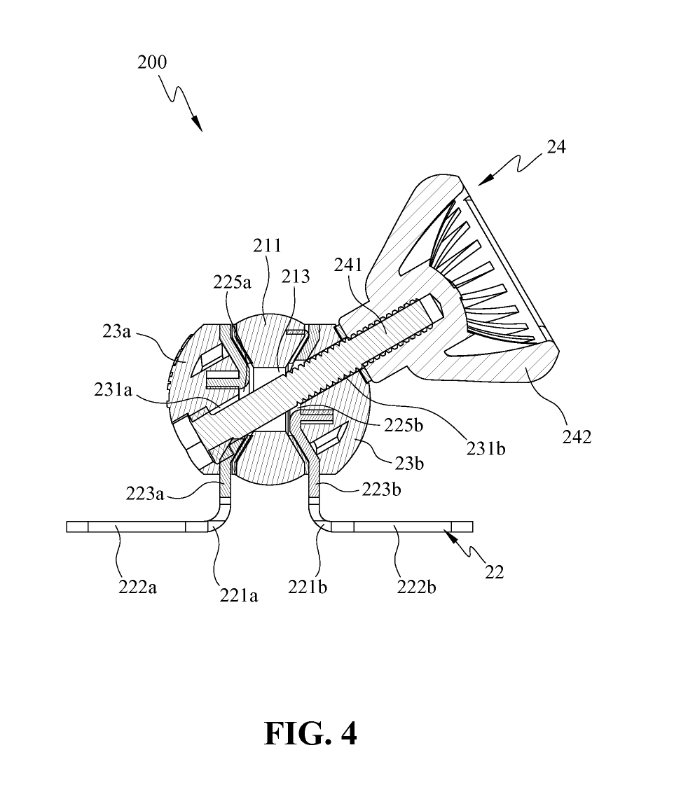

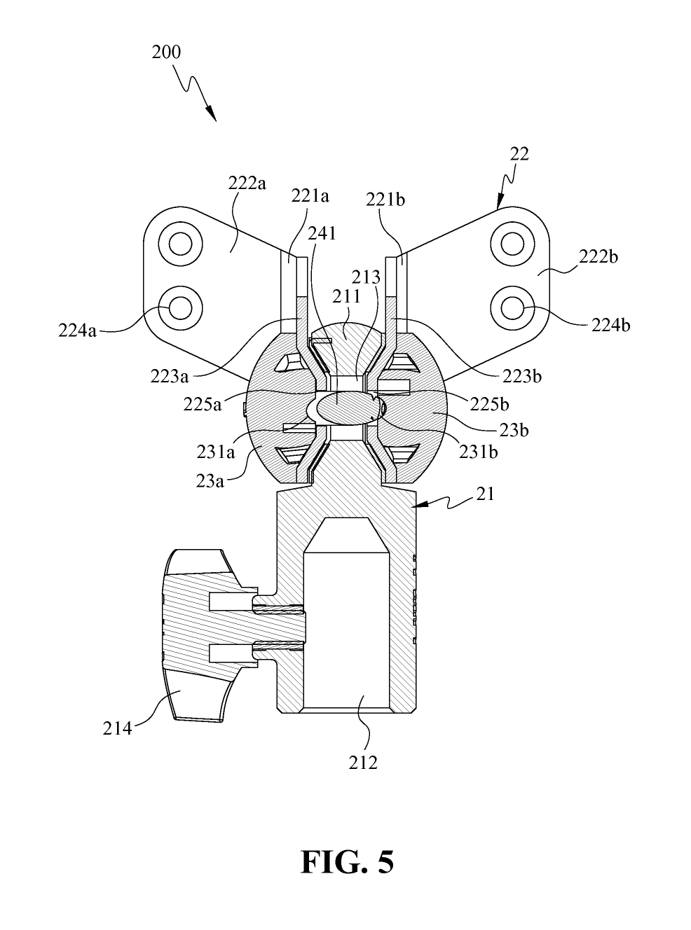

Referring to FIGS. 2-5, a fastening structure 200 for a lamp holder according to the present invention comprises a main body 21, a mounting unit 22, a pair of securing members 23a, 23b, and a first securing unit 24 including a screw 241 and a knob 242 engaged at an end of the screw 241.

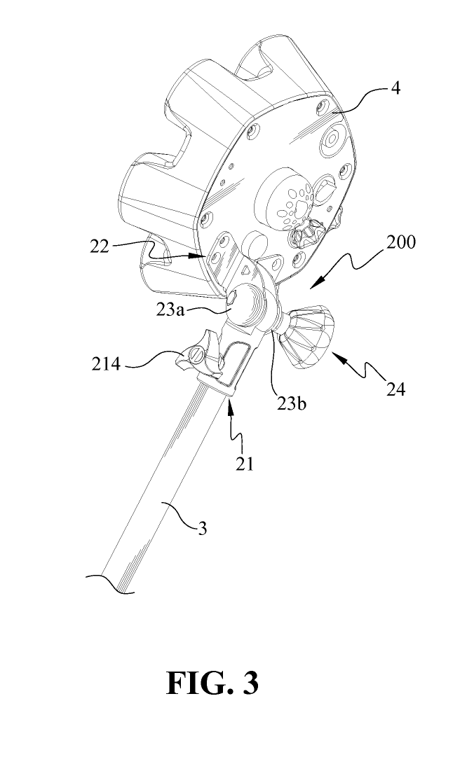

One end of the main body 21 has an assembly hole 212 for being engaged to a supporter 3. The other end of the main body 21 is extended with an engagement portion 211 for being engaged with the mounting unit 22 and further engaged to a lamp holder 4 (see FIGS. 2-3). The main body 21 is equipped with a second securing unit 214 at the end corresponding to the assembly hole 212 for being secured on the supporter 3. The engagement portion 211 of the main body 21 has a transversely central hole 213 for being assembled with the mounting unit 22 by means of the securing members 23a, 23b and the first securing unit 24.

The mounting unit 22 includes a pair of mounting members 221a, 221b both having symmetrical structures to each other and preferably made of metal material. The mounting members 221a, 221b include a first mounting portion 222a, 222b and a second mounting portion 223a, 223b, respectively. The first mounting portions 222a, 222b have at least one mounting hole 224a, 224b (each first mounting portion having two holes in this embodiment) for being secured with the lamp holder 4. The second mounting portions 223a, 223b have engagement holes 225a, 225b, respectively, staggered with each other at an assembled state with the main body 21.

In assembling, the mounting members 221a, 221b are mounted at two sides of the engagement portion 211 of the main body 21, and then the securing members 23a, 23b are mounted at two sides of the mounting members 221a, 221b, respectively. Finally, the mounting unit 22 and the main body 21 are secured together by the engagement of the screw 241 of the first securing unit 24 along an inclined angle with the engagement holes 225a, 225b of the mounting unit 22, the central hole 213 of the engagement portion 211 of the main body 21, and engagement holes 231a, 231b of the securing members 23a, 23b.

The main technical feature of the fastening structure for a lamp holder according to the present invention is that the mounting unit 22 and the main body 21 are secured together by the first securing unit 24 along an inclined angle. Thus, it is very convenient to assemble the lamp holder to the fastening structure without causing any interference of the first securing unit 24 with the lamp holder and other components, for example a canopy, during assembling. Furthermore, it is also to provide a more sufficient space for securing the lamp holder 4 to the mounting unit 22 by the first securing unit 24, and it is also more convenient in operating the first securing unit 24. In addition, the second mounting portion 223a, 223b of the mounting members 221a, 221b can be designed to be shorter in length than the conventional structures. With such a special design, the fastening structure of the present invention has the advantages of being capable of being rapidly and conveniently assembled to or disassembled from the lamp holder, which improve the shortcomings of the conventional fastening structures.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A fastening structure for a lamp holder, comprising:
a main body, one end of the main body having an assembly hole, the other end of the main body being extended with an engagement portion, the engagement portion having a transversely central hole;
a mounting unit, mounted at a side of the engagement portion of the main body; and
a first securing unit, passing through the transversely central hole of the engagement portion of the main body and securing the mounting unit to the engagement portion of the main body along an inclined angle.

2. The fastening structure according to claim 1, wherein the mounting unit comprises a pair of mounting members.

3. The fastening structure according to claim 2, wherein the mounting members each comprises a first mounting portion and a second mounting portion, the first mounting portion has at least one mounting hole, and the second mounting portion has an engagement hole.

4. The fastening structure according to claim 1, further comprising a pair of securing members mounted at two sides of the engagement portion of the main body for securing the mounting unit.

5. The fastening structure according to claim 1, wherein the first securing unit comprises a screw and a knob engaged at an end of the screw.

6. The fastening structure according to claim 1, wherein a second securing unit is disposed at the end of the main body having the assembly hole.
